(19) United States
(12) Patent Application Publication
(10) Pub. No.: US 2013/0003010 A1
(43) Pub. Date: Jan. 3, 2013

(54) CAMERA MODULE AND METHOD FOR MAKING SAME

(75) Inventor: YUN-KAI YU, Tu-Cheng (TW)

(73) Assignee: HON HAI PRECISION INDUSTRY CO., LTD., Tu-Cheng (TW)

(21) Appl. No.: 13/198,719

(22) Filed: Aug. 5, 2011

(30) Foreign Application Priority Data
Jun. 29, 2011 (TW) 100122724

(51) Int. Cl. G03B 3/04; B29C 45/00; B23K 31/02

(52) U.S. Cl. 349/200; 228/248.1; 228/164

(57) ABSTRACT

A camera module includes a lens module, a circuit board and solder balls. The lens module includes a lens holder, a liquid crystal lens, and wires. The lens holder includes an outer surface, a first end portion, and a second end portion at opposite sides of the lens holder. The lens holder defines wire grooves in the first and second end portions and the outer surface. The liquid crystal lens is received in the first end portion. The wires are formed on the first end portion The outer surface and the second end portion in the wire grooves are electrically connected to the liquid crystal lens. Each wire includes a solder terminal. The circuit board includes solder pads each corresponding to the solder terminal The solder balls each interconnect the solder pad and the corresponding solder terminal and are formed by low-temperature solder paste composed of tin and bismuth.

### BACKGROUND

1. Technical Field

The present disclosure relates to camera modules, and also to a method for making the camera modules.

2. Description of Related Art

Optical zooming is a common function of camera modules. Lenses are driven by a driving mechanism to move along an optical axis of a lens module contained in the camera module to achieve zooming The driving mechanism includes a motor, such as a step motor or a voice coil motor and a related guiding mechanism. However, the driving mechanism is bulky, which adds to the size of the camera module.

Therefore, what is needed is a camera module and a method for making the camera module that can overcome the limitations described above.

### BRIEF DESCRIPTION OF THE DRAWINGS

FIG. 1 is an isometric and schematic view of a camera module, according to an exemplary embodiment.

FIG. 2 is an exploded view of the camera module of FIG. 1.

### DETAILED DESCRIPTION

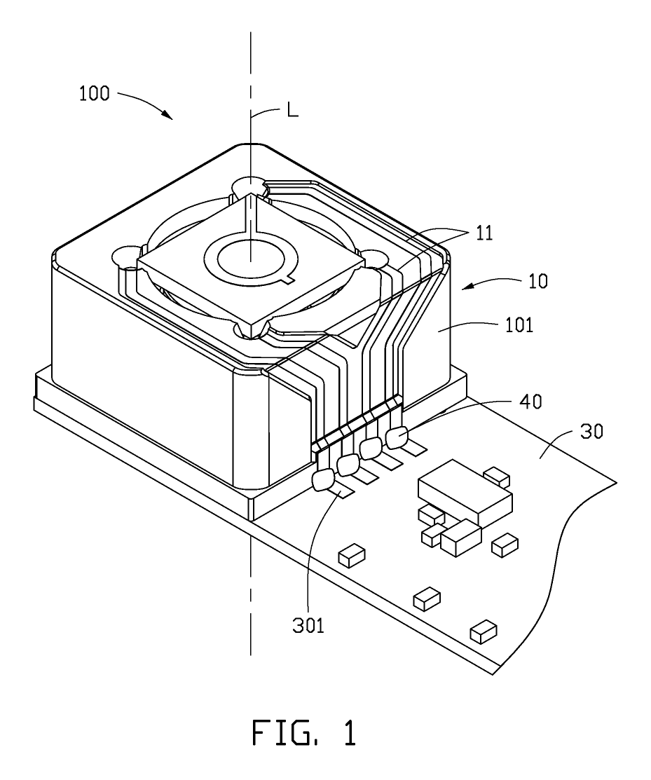

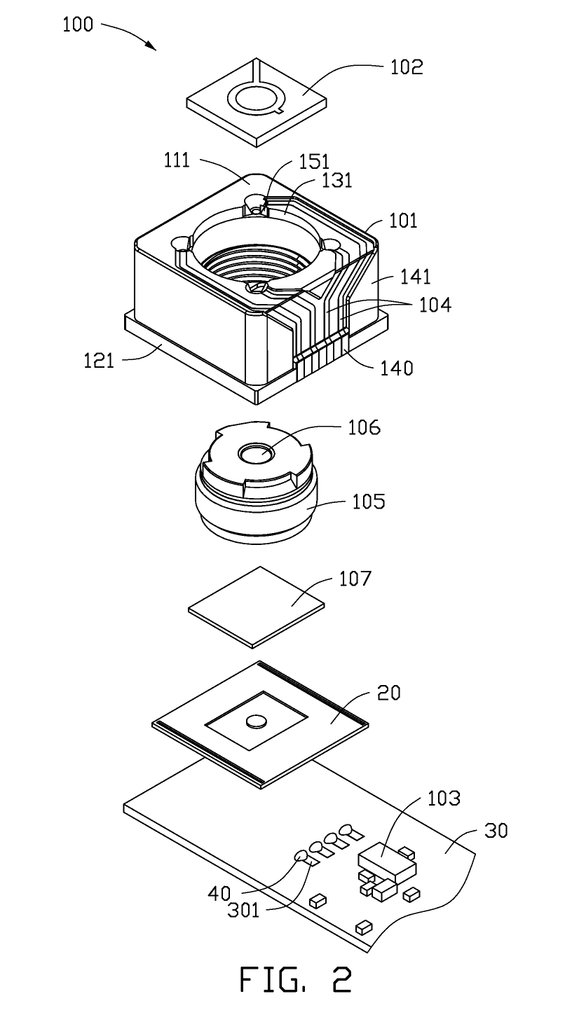

Referring to FIGS. 1 and 2, a camera module 100, according to a first exemplary embodiment, includes a lens module 10, an image sensor 20, a circuit board 30, and a number of solder balls 40.

The lens module 10 includes a lens holder 101, a liquid crystal lens 102, a driving unit 103, a number of wires 104, a lens barrel 105, and an optical lens group 106 and an infrared-cut filter 107.

Material of the lens holder 101 can be selected from a group consisting of semi-aromatic polyamide based on Ultramid®, thermoplastic polyester based on Pocan®, crosslinked polybutylene terephthalate based on Vestodur®, and liquid crystal polymer based on Vectra®. The lens holder 101 includes an outer surface 141, a first end portion 111, and a second end portion 121. The first end portion 111 and the second end portion 121 are at opposite sides of the lens holder 101. The first end portion 111 is adjacent to an object side of the lens module 10. The second end portion 121 is adjacent to an image side of the lens module 10. The outer surface 141 connects the first end portion 111 to the second end portion 121. The outer surface 141 encircles and is substantially parallel to an optical axis L of the lens module 101. The lens holder 101 defines a number of wire grooves 11 in the first end portion 111, the outer surface 141, and the second end portion 121.

The first end portion 111 defines a round receiving space 131. The receiving space 131 communicates with the wire grooves 11. The liquid crystal lens 102 is received in the receiving space 131. Specifically, the receiving space 131 includes four corner grooves 151. The liquid crystal lens 102 is substantially cuboid-shaped. Four corners of the liquid crystal lens 102 are received in the four corner grooves 151 respectively.

The driving unit 103 is attached to the circuit board 30. The driving unit 103 is configured for driving the liquid crystal lens 102 to zoom. The driving unit 103 may include a driver IC.

The wires 104 are formed on the outer surface 141, the first end portion 111 and the second end portion 121 in the wire grooves 11. Each wire 104 includes a solder terminal 140. As such, the camera module 100 can be compact in design.

The lens barrel 105 is received in the lens holder 101. The liquid crystal lens 102 and the lens barrel 105 are arranged in the order written from the object side to the image side of the lens module 10. The optical lens group 106 is received in the lens barrel 105. The optical lens 106 may include one or more non-zoom lenses made of glass or plastic. The liquid crystal lens 102 and the optical lens group 106 are arranged in the order written from the object side to the image side of the lens module 10. The optical lens group 106 and the liquid crystal lens 102 constitute an imaging lens system for the camera module 100. Changes made to the focal length of the liquid crystal lens 102 results in changes of the effective focal length of the image lens system, thereby achieving optical zooming of the camera module 100. This can achieve a compact camera module 100 with optical zooming

The infrared-cut filter 107 and the image sensor 20 are received in the second end portion 121 in that order from the object side to the image side of the lens module 10. The infrared-cut filter 107 prevents infrared light from entering the image sensor 20 and prevents dust and/or water vapor from contaminating the image sensor 20. The liquid crystal lens 102, the optical lens group 106, the infrared-cut filter 107 and the image sensor 20 are arranged in the order written from the object side to the image side of the lens module 10.

The lens holder 101 is positioned on the circuit board 30. The lens holder 101 and the circuit board 30 cooperatively seal the image sensor 20 in the second end portion 121. The image sensor 20 is positioned on the circuit board 30. The circuit board 30 is electrically connected to the image sensor 20 and the driving unit 103. The circuit board 30 includes a number of solder pads 301. Each solder pad 301 is aligned with a corresponding solder terminal 140. Each solder ball 40 interconnects the solder pad 301 and the corresponding solder terminal 140 so that the driving unit 103 and the circuit board 30 can be electrically connected to the liquid crystal lens 102. The solder ball 40 is formed by a low-temperature solder paste composed of tin and bismuth (Sn—Bi). The solder paste composed of tin and bismuth has a low melting point of about 139° C. relative to the solder paste composed of tin and gold and copper (Sn—Ag—Cu).

A method for making the camera module 100, according to a second embodiment, includes steps S100 through S110. S100: a circuit board 30, a lens module 10 and a low-temperature solder paste are provided. The low-temperature solder paste is composed of tin and bismuth. The circuit board 30 includes a number of solder pads 301. The lens module includes a lens holder 101, a liquid crystal lens 102 and a number of wires 104. The lens holder 101 includes an outer surface 141, a first end portion 111 adjacent to an object side of the lens module 10 and a second end portion 121 adjacent to an image side of the lens module 10. The first end portion 111 and the second end portion 121 are at opposite sides of the lens holder 101. The outer surface 141 connects the first end portion 111 to the second end portion 121 and is substantially parallel to an optical axis L of the lens module 10. The lens holder 101 defines a number of wire grooves 11 in the first end portion 111, the outer surface and the second end portion. The liquid crystal lens 102 is received in the first end portion 111. The wires 104 are formed on the first end portion 111, the outer surface 141 and the second end portion 121 in the wire grooves 11 and are electrically connected to the liquid crystal lens 102. Each wire 104 includes a solder terminal 140. S102: the solder paste is attached to the solder pads 301. S104: the lens module 10 is positioned on the circuit board 30 to align the solder terminals 140 with corresponding solder pads 301, and the solder terminals 140 are made come into contact with the solder paste. S106: the solder paste is heated to interconnect the solder terminals 140 and the solder pads 301. S108: the solder paste is cooled to form a number of solder balls each interconnecting the solder terminal 140 and the corresponding solder pad 301.

In step S100, the lens module 10 is provided through steps S200 to S210. S200: the lens holder 101 using a laser-activated material is formed using an injection-molding process. Step S202: the wire grooves 11 are defined in the outer surface 141, the first end portion 111, and the second end portion 121 of the lens holder 101 using a laser beam. Step S204: the wires 104 are formed in the wire grooves 11. Step S206: the liquid crystal lens 102 is attached to the first end portion 111. Step S208: the liquid crystal lens 102 is electrically connected to the wires 104. Step S210: a driving unit 103 is attached on the circuit board 30 and is electrically connected to the wires 104, the driving unit 103 is configured for driving the liquid crystal lens 102 to zoom.

In the step S200, the laser-activated material can be selected from a group consisted of semi-aromatic polyamide based on Ultramid®, thermoplastic polyester based on Pocan®, crosslinked polybutylene terephthalate based on Vestodur®, liquid crystal polymer based on Vectra®. The lens holder 101 is formed by a single-shot injection-molding process.

In the step S202, the laser beam may be emitted from a diode-pumped infrared laser generator. The wave length of the laser beam can be about 1064 nanometers. The predetermined regions can be designed by a computer aided design (CAD) in the computer. The laser beam directly transfers such design from the computer to the lens holder 101. The predetermined regions can be easily changed/adjusted by changing the existing CAD data. Thus, design of the lens module 10 and the camera module 100 can be more flexible.

In step S204, forming the wires 104 in the wires grooves 11 includes sub-steps S240 through S242. Sub-step S240: the lens holder 101 with the wire grooves 11 is cleaned to remove any contaminants. Sub-step S242: the lens holder 101 is metalized to form the wires 104 in the wire grooves 11.

In the sub-step S242, metallization of the lens holder 101 is achieved with the help of current-free copper baths. This copper baths typically deposit a copper coating with the speed of about 3 μm-about 5 μm per hour on the lens holder 101. If a greater thickness of copper coating is required, this is achieved using standard electroforming copper baths. Furthermore, application-specific coatings such as Ni, Au, Sn, Sn/Pb, Ag, Ag/Pd, etc., can also be created.

In step S102, the solder paste may be attached to the solder pads 301 by a screen printer in a surface-mounted-technology process. In step S106, a welding torch machine may be used to heat the solder paste. When heated, the solder paste can move to the solder terminal 140 because of the wetting ability of the solder paste. The temperature of heating is in a range from about 200° C. to about 250° C. , and a time period of heating is about 0.5 seconds.

It is to be understood that, the driving unit 103 may be positioned to the outer surface 141 of the lens holder 101.

It is to be understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A camera module comprising:
a lens module comprising
a lens holder comprising an outer surface, a first end portion adjacent to an object side of the lens module and a second end portion adjacent to an image side of the lens module, the first end portion and the second end portion being at opposite sides of the lens holder, the outer surface connecting the first end portion to the second end portion and being substantially parallel to an optical axis of the lens module, the lens holder defining a plurality of wire grooves in the first end portion, the outer surface and the second end portion;
a liquid crystal lens received in the first end portion;
a plurality of wires formed on the first end portion, the outer surface and the second end portion in the wire grooves, the wires being electrically connected to the liquid crystal lens, each wire comprising a solder terminal;
a circuit board, the circuit board comprising a plurality of solder pads each corresponding to the solder terminal, the lens holder positioned on the circuit board; and
a plurality of solder balls each interconnecting the solder pad and the corresponding solder terminal, the solder balls formed by low-temperature solder paste composed of tin and bismuth.

2. The camera module of claim 1, wherein the lens module comprises a lens barrel and an optical lens group received in the lens barrel, the lens barrel is received in the lens holder, the liquid crystal lens and the lens barrel are arranged in the order written from the object side to the image side of the lens module.

3. The camera module of claim 1, further comprising a driving unit attached to the circuit board and electrically connected to the solder pads and configured for driving the liquid crystal lens to zoom.

4. The camera module of claim 1, wherein the first end portion defines a round receiving space in communication with the wire grooves, the liquid crystal lens being received in the receiving space.

5. The camera module of claim 4, wherein the receiving space comprises four corner grooves, four corners of the liquid crystal lens being received in the four corner grooves respectively.

6. The camera module of claim 1, further comprising an image sensor received in the second end portion and positioned on the circuit board, the lens holder and the circuit board cooperatively sealing the image sensor.

7. The camera module of claim 6, further comprising an infrared-cut filter received in the lens holder adjacent to the object side of the lens module.

8. A method for making a camera module, comprising steps of:
providing a circuit board, a lens module and a low-temperature solder paste composed of tin and bismuth, the circuit board comprising a plurality of solder pads, the lens module comprising a lens holder, a liquid crystal lens and a plurality of wires, the lens holder comprising an outer surface, a first end portion adjacent to an object side of the lens module and a second end portion adjacent to an image side of the lens module, the first end portion and the second end portion being at opposite sides of the lens holder, the outer surface connecting the first end portion to the second end portion and being substantially parallel to an optical axis of the lens module, the lens holder defining a plurality of wire grooves in the first end portion, the outer surface and the second end portion, the liquid crystal lens received in the first end portion, the wires formed on the first end portion, the outer surface and the second end portion in the wire grooves and electrically connected to the liquid crystal lens, each wire comprising a solder terminal;
attaching the solder paste to the solder pads;
positioning the lens module on the circuit board to align the solder terminals with corresponding solder pads, and make the solder terminals come into contact with the solder paste;
heating the solder paste to interconnect the solder terminals and the solder pads; and
cooling the solder paste to form a plurality of solder balls.

9. The method of claim 8, wherein the temperature of heating is in a range from about 200° C. to about 250° C., and a time period of heating is about 0.5 seconds.

10. The method of claim 8, wherein the step of providing the lens module, comprises:
forming the lens holder using a laser-activated material using an injection-molding process;
defining the wire grooves in the outer surface, the first end portion, and the second end portion using a laser beam;
forming the wires in the wire grooves;
attaching the liquid crystal lens to the first end potion; and
electrically connecting the liquid crystal lens to the wires.

11. The method of claim 10, wherein the step of providing the lens module further comprises attaching a driving unit on the circuit board, and electrically connecting the driving unit to the solder pads, the driving unit configured for driving the liquid crystal lens to zoom.
